(19) United States
(12) Patent Application Publication
(10) Pub. No.: US 2004/0237060 A1
(43) Pub. Date: Nov. 25, 2004

(54) Integrated circuit device, clock layout system, clock layout method, and clock layout program

(76) Inventors: Mutsunori Igarashi, Kanagawa-ken (JP); Fumihiro Minami, Kanagawa-ken (JP)

Correspondence Address: GRAY CARY WARE & FREIDENRICH LLP, 2000 UNIVERSITY AVENUE, E. PALO ALTO, CA, 94303-2248, US

(21) Appl. No.: 10/805,006

(22) Filed: Mar. 18, 2004

(30) Foreign Application Priority Data
Mar. 24, 2003 (JP) P2003-081321

(51) Int. Cl. G06F 17/50

(52) U.S. Cl. 716/12; 716/13; 716/6; 716/10

(57) ABSTRACT

A clock layout method comprises accepting circuit information on a logic circuit, placing a route driver on a semiconductor chip and forming initial clock routing with an H-tree structure in a local area and with a star structure in a global area, specifying a second node which first appears on a first wire among a plurality of wires branching from an arbitrary first node in the initial clock routing, specifying at least a third node which is the second to appear on a wire other than the first wire among the plurality of wires branching from the first node, defining the defined third node which exists in a direction within a predetermined angle from an input direction of a signal inputted to the second node, among the third nodes, folding a wire from the first node up to the defined third node and a node present therebetween.

### CROSS-REFERENCE TO RELATED APPLICATIONS

This application is based upon and claims the benefit of priority from the prior Japanese Patent Application No. 2003-81321, filed Mar. 24th 2003, the entire contents of which are incorporated herein by reference.

### FIELD OF THE INVENTION

The present invention relates to a computer-aided design technology for integrated circuit devices. The present invention relates particularly to a clock layout system, a clock layout method and a clock layout program for designing clock routing in an integrated circuit device, and further to an integrated circuit device having the clock routing realized by the same.

### BACKGROUND OF THE INVENTION

In clock routing, it is preferable that skew is eliminated in all the output signals in order to prevent malfunction. “Skew” is the time difference among propagation delays of signals. No existence of skew is called “zero skew”.

As a method for realizing “zero skew”, there is a method in which clock routing using an “H-tree structure” is performed, as shown in FIG. 9A. Latches 115 and 116, latches 117 and 118, latches 119 and 120, and latches 121 and 122 are connected with each other by wires 125 to 128, respectively. Wires 125 to 128 have the same delays. Next, the midpoint of wire 125 is connected with the midpoint of wire 126 by a wire 131, and the midpoint of wire 127 with the midpoint of wire 128 by a wire 132. Wires 131 and 132 have the same delays. Further, the midpoint of wire 131 is connected with the midpoint of wire 132 by a wire 141 having the same delay. The “H-tree structure” is a structure used for equalizing propagation delays of a clock by repeating the routing processing as described above.

As another method for realizing “zero skew”, there is a method in which clock routing using a “star structure” is performed, as shown in FIG. 9B. The “star structure” is a structure in which wires 71a to 76a are branched from a route driver 70 and connected to clock input terminals of latches 51 to 56 by wires 71b to 76b respectively, with buffers 61 to 66 interposed between wires 71a to 76a and wires 71b to 76b respectively. In such routing, the lengths of wires 71a to 76a, as well as the lengths of wires 71b to 76b, are equalized, and the number of buffers 61 to 66 to be inserted is equalized. Thus, the propagation delays of a clock to reach the clock input terminals of latches 51 to 56 from route driver 70 are equalized.

As another method for improving the performance of a circuit, there is a method of configuring a circuit in which useful skew is achieved. “Useful skew” is skew in output signals within a range where synchronization with a clock is possible. “Useful skew” is achieved by setting a target delay in each node to be a leaf of a tree. “Setting a target delay” means that a propagation delay of a clock is adjusted by inserting a buffer and/or an amplifier, extending/shortening a clock wire, and the like.

In a large scale integrated circuit, it is difficult to perform routing of all the circuit elements mounted on a semiconductor chip with an H-tree structure. As shown in FIG. 9A, one of buffers 150 to 157 is inserted at each junction in the H-tree structure. Accordingly, the space utilization is low, and an area is limited where routing can be performed using the H-tree structure. Moreover, in the H-tree structure, as an electric current comes nearer to a route driver, the electric current is gradually concentrated and therefore becomes large. Accordingly, electromigration occurs.

A method is generally adopted in which, as shown in FIG. 9C, H-tree structures are used in local areas 91 to 96 (hereinafter, referred to as “local area”), and a star structure is used in the entire area (hereinafter, referred to as “global area”) of a chip. In order to reduce a routing space, routing is performed using an H-tree structure in a local area and using a star structure in the entire area of a chip.

If the number of branches from a route driver 702 is increased in the global area, the electric current has to be increased up to a level at which route driver 702 can be driven. Thus, the current capacitance may exceed a value determined by the constraints of electromigration. Moreover, if the number of local areas is increased, the number of wires from route driver 702 to the local areas is increased. Thus, the required routing space and the power consumption by the wires are increased. If the number of branches from route driver 702 and from buffers 61 to 66 is increased, the degrees of cell congestion and wire congestion are increased in the vicinities of route driver 702 and buffers 61 to 66. As a result, wiring short circuit and the like may occur at the stage of layout design, and the routability (probability of perfect connection) is lowered.

### SUMMARY OF THE INVENTION

A semiconductor device according to an embodiment of the present invention comprises ( [symbol] )

### BRIEF DESCRIPTION OF THE DRAWINGS

FIG. 1 is a view schematically showing clock routing in an integrated circuit device according to a first embodiment of the present invention.

FIG. 2 is a view schematically showing a clock layout system according to the first embodiment of the present invention.

FIG. 3A is a view schematically showing clock routing before folding.

FIG. 3B is a view schematically showing the clock routing after folding.

FIG. 4 is a flow chart for explaining a clock layout method according to the first embodiment of the present invention.

FIG. 5A is a view schematically showing detour routing for adjusting a propagation delay of a clock only by use of orthogonal wires.

FIG. 5B is a view schematically showing clock routing in an integrated circuit device according to a second embodiment of the present invention.

FIG. 5C is a view showing wiring directions.

FIG. 6 is a view schematically showing a clock layout system according to the second embodiment of the present invention.

FIG. 7 is a flow chart for explaining a clock layout method according to the second embodiment of the present invention.

FIG. 8 is a view showing clock routing where routing is started from the vicinity of the centroids of each of F/F groups.

FIG. 9A is a view schematically showing clock routing using an H-tree structure.

FIG. 9B is a view schematically showing clock routing using a star structure.

FIG. 9C is a view schematically showing clock routing using H-tree structures and a star structure at the same time.

### DETAILED DESCRIPTION OF THE INVENTION

Embodiments of the present invention will be described in detail with reference to the drawings. In the following description of the drawings, the same or similar reference numerals and symbols will be used to designate the same or similar components and portions. It should be noted, however, that the drawings are schematic representations.

### First Embodiment

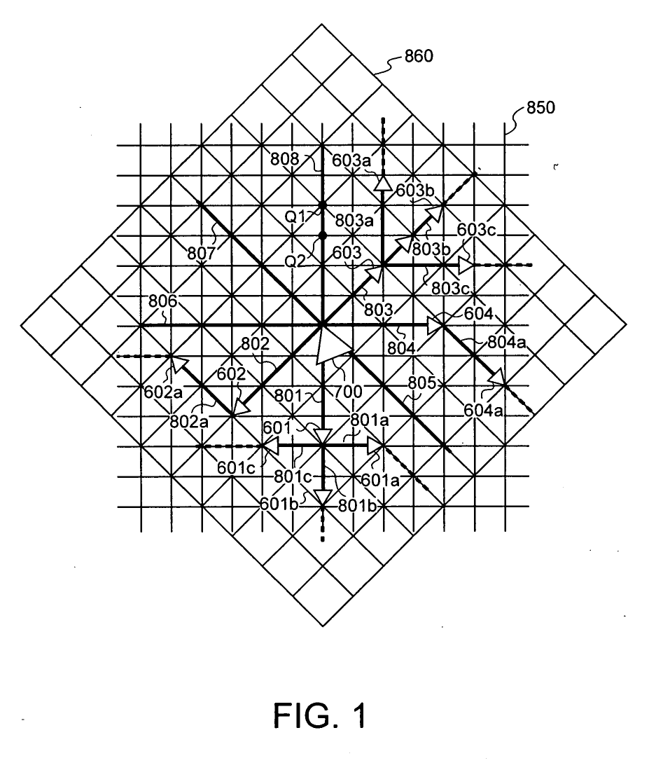

As shown in FIG. 1, in clock routing in an integrated circuit device according to a first embodiment of the present invention, eight main wires (parent wires) 801 to 808 isotropically branch from a route driver 700. Branch wires (subordinate wires) 801a, 801b and 801c branch from a buffer 601 on main wire 801 and lead to buffers 601a, 601b and 601c, respectively. A branch wire 802a extends from a buffer 602 on main wire 802 to a buffer 602a. Branch wires 803a, 803b and 803c branch from a buffer 603 on main wire 803 and lead to buffers 603a, 603b and 603c, respectively. A branch wire 804a extends from a buffer 604 on main wire 804 to a buffer 604a.

Buffer 601 is a second node that first appears on wire 801 of the plurality of wires 801 to 808 which branch from an arbitrary first node (route driver 700). Buffers 601a, 601b and 601c are third nodes that exist in directions which branch from the second node (buffer 601) and which are within predetermined angles, e.g. angles of 90°, from the input direction of a signal inputted to the second node (direction from the second node toward buffer 601b). Folding toward these third nodes (buffers 601a, 601b, 601c) is performed, and the clock wires (801a, 801b, 801c) are connected thereto.

Buffer 602 is a second node that first appears on wire 802 of the plurality of wires 801 to 808 which branch from the arbitrary first node (route driver 700). Buffer 602a is a third node that exists in a direction which extends from this second node (buffer 602) and which is within angles of 90° from the input direction of a signal inputted to the second node. Folding toward this third node (buffer 602a) is performed, and the clock wire (802a) is connected thereto.

Buffer 603 is a second node that first appears on wire 803 of the plurality of wires 801 to 808 which branch from the arbitrary first node (route driver 700). Buffers 603a, 603b and 603c are third nodes that exist in directions which branch from this second node (buffer 603) and which are within angles of 90° from the input direction of a signal inputted to the second node. Folding toward these third nodes (buffers 603a, 603b, 603c) is performed, and the clock wires (803a, 803b, 803c) are connected thereto.

Buffer 604 is a second node that first appears on wire 804 of the plurality of wires 801 to 808 which branch from the arbitrary first node (route driver 700). Buffer 604a is a third node that exists in a direction which extends from this second node (buffer 604) and which is within angles of 90° from the input direction of a signal inputted to the second node. Folding toward this third node (buffer 604a) is performed, and the clock wire (804a) is connected thereto.

In FIG. 1, a diagonal wiring matrix 860 is used in addition to an orthogonal wiring matrix 850. Therefore, the grid of orthogonal wiring matrix 850 and the grid of diagonal wiring matrix 860 intersect each other as at Q1 on wire 808. There are nodes, such as Q1, where routing is possible in eight directions, and nodes, such as Q2, where routing is possible only in four directions. At Q2, orthogonal wiring matrix 850 does not intersect diagonal wiring matrix 860.

An expression “directions within angles of 45° from the input direction of a signal” means directions at angles of 0°, +45° and −45° from the input direction of a signal at a node such as Q1. At least one of the wires in these three directions branches or extends from the node. An expression “directions within angles of 90° from the input direction of a signal” means directions at angles of 0°, +45°, −45°, +90° and −90° from the input direction of a signal at a node such as Q2 or Q1. At least one of the wires in these five directions branches or extends from the node.

As a result, detour wires are eliminated except for wires necessary for setting of a target delay. The congestion of wires in the vicinities of buffers 601 to 604 can be prevented, and the routability is improved.

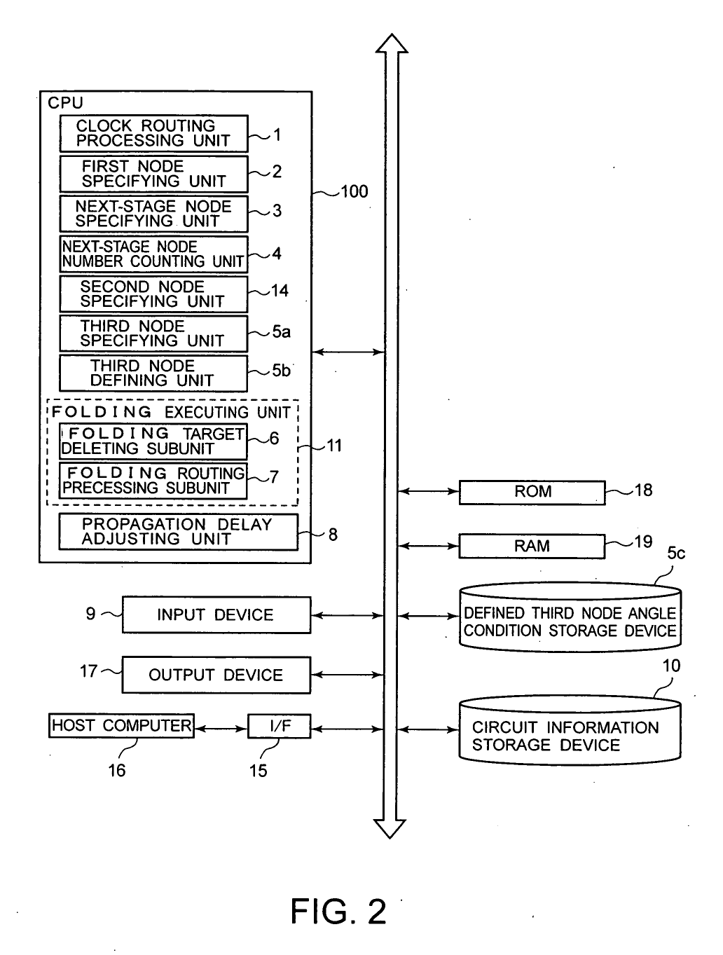

A description will be given of a clock layout system according to the first embodiment of the present invention with reference to FIG. 2. The clock layout system according to the first embodiment of the present invention includes an input device 9, a central processing unit (CPU) 100, an output device 17, an interface 15, a host computer 16, a defined third node angle condition storage device 5c, a circuit information storage device 10, a read only memory (ROM) 18, a random access memory (RAM) 19, and a common bus 20.

Input device 9 provides an input of circuit information on a logic circuit to be designed to a clock routing processing unit 1. Output device 17 outputs data processed by CPU 100. Host computer 16 retains the same data as the data to be outputted by output device 17 via interface 15 and provides an output of the data on a monitor or the like. Input device 9, CPU 100, output device 17, interface 15, host computer 16, defined third node angle condition storage device 5c, circuit information storage device 10, ROM 18, and RAM 19 communicate data with one another via common bus 20.

CPU 100 includes clock routing processing unit 1, a first node specifying unit 2, a next-stage node specifying unit 3, a next-stage node number counting unit 4, a second node specifying unit 14, a third node specifying unit 5a, a third node defining unit 5b, a folding executing unit 11, and a propagation delay adjusting unit 8. Folding executing unit 11 includes a folding target deleting subunit 6 and a folding routing processing subunit 7.

Clock routing processing unit 1 places a route driver on a semiconductor chip, based on the circuit information on the logic circuit inputted through input device 9. Clock routing is performed with an H-tree structure in a local area and with a star structure in the global area. The clock routing performed here is for a design, and the clock wiring does not need to be actually done.

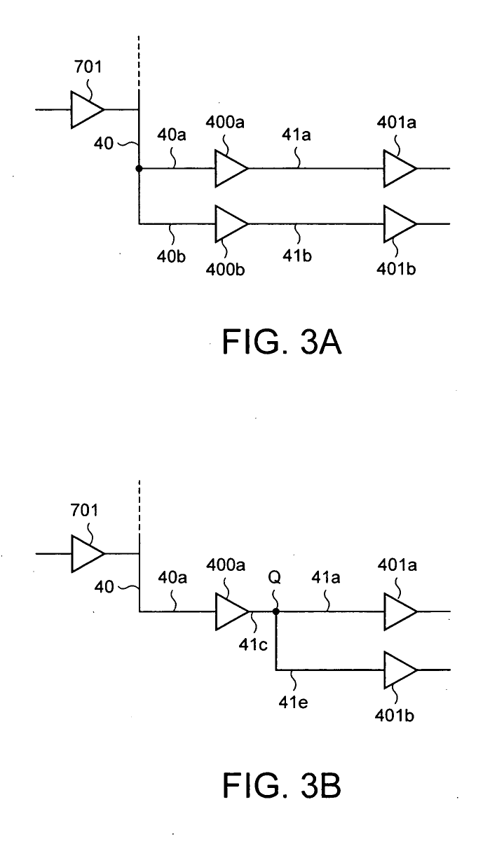

First node specifying unit 2 first specifies the route driver placed by clock routing processing unit 1 as a first node. As shown in FIG. 3A, for example, a route driver 701 becomes the first node.

Next-stage node specifying unit 3 specifies, as a next-stage node, a node which first appears in a signal propagation direction from the first node specified by first node specifying unit 2. In FIG. 3A, buffers which first appear in signal propagation directions from first node 701 become next-stage nodes 400a, 400b, . . . .

Next-stage node number counting unit 4 counts the number of the next-stage nodes specified by next-stage node specifying unit 3.

Second node specifying unit 14 specifies, as a second node, one of the next-stage nodes specified by next-stage node specifying unit 3. In FIG. 3A, next-stage node 400a is assumed to be the second node.

Third node specifying unit 5a specifies, as a third node, a node which first appears in a signal propagation direction from one of the next-stage nodes different from the second node, on condition that there is at least no increase in propagation delay of a clock propagated from the first node to the third node after folding. In FIG. 3A, a node 401b which first appears in a signal propagation direction from next-stage node 400b different from second node 400a, is assumed to be the third node.

A description will be given below of “folding”. As shown in FIGS. 3A and 3B, node 400a that first appears on a first wire 40a of a plurality of wires 40a, 40b, . . . which branch from first node 701 being the route driver is specified as the second node. Node 401b that is the second to appear on a wire 40b other than the first wire among the plurality of wires 40a, 40b, . . . which branch from first node 701 is specified as the third node. Thereafter, wires 40b, 41b and node 400b on a route from first node 701 to third node 401b are deleted. A new wire 41e is branched from a first wire 41c at second node 400a and connected to third node 401b.

Although there is one third node in FIG. 3A, a plurality of third nodes may exist. In this case, wires and nodes on routes from first node 701 to the third nodes are deleted. A plurality of new wires are branched from first wire 41c at second node 400a and connected to the respective third nodes.

A description will be given below of a condition that “there is at least no increase in propagation delay of a clock after folding”. The condition means that, for example, when folding has been performed as shown in FIG. 3B, a propagation delay in a route from first node 701 to third node 401b is not increased as compared with a propagation delay in a route from first node 701 to node 401b in FIG. 3A. In FIG. 3A, a clock propagates from first node 701 through wires 40, 41b, node 400b, and wire 41b and reaches node 401b. In FIG. 3B, a clock propagates from first node 701 through wires 40, 40a, node 400a, wire 41c, and wire 41e and reaches third node 401b.

Third node defining unit 5b defines, as a defined third node, a third node that meets a condition stored in the defined third node angle condition storage device 5c, among third nodes specified by third node specifying unit 5a. For example, a case is considered where a condition to be met for third node defining unit 5b is that “a defined third node exists in a direction within angles of 90° from the input direction of a signal inputted to the second node”. Third nodes 401b, . . . which exist in directions within angles of 90° from the input direction of a signal inputted to second node 400a, in other words, from the direction of wire 40a, become the defined third nodes. Other conditions include a condition that “a defined third node exists in a direction within angles of 45° from the input direction of a signal inputted to the second node”, and the like.

These conditions may include a combination of a plurality of conditions. For example, it may be possible to impose a condition that in the case of a node, such as Q1 shown in FIG. 1, where routing is possible in eight directions, a defined third node exists in a direction within angles of 45° from the input direction of a signal inputted to the second node, and that in the case of a node, such as Q2, where routing is possible only in four directions, a defined third node exists in a direction within angles of 90° from the input direction of a signal inputted to the second node.

Folding executing unit 11 performs folding on the defined third node(s) defined by third node defining unit 5b. When the current capacitance exceeds a level at which the second node, specified by second node specifying unit 14, can be driven, folding executing unit 11 determines that the folding cannot be performed. Therefore, folding is performed on the defined third node(s) first in a range of not exceeding the current capacitance, and then folding is performed on the rest of the defined third nodes from another second node.

Folding target deleting subunit 6 deletes a line branching from the first node up to a defined third node, and a node on the line branching from the first node up to the defined third node. For example, wires 40b and 41b branching from first node 701 and leading to defined third node 401b, and node 400b, which are shown in FIG. 3A, are deleted as shown in FIG. 3B.

Folding routing processing subunit 7 branches a wire from the second node and connects the wire to the defined third node. As shown in FIG. 3B, for example, wire 41e is branched from second node 400a at a point Q and connected to defined third node 401b.

Further, after the folding, first node specifying unit 2 specifies the second node specified by second node specifying unit 14 as a new first node. This means, for example, as shown in FIG. 3B, node 400a after the folding is specified as a new first node. By specifying node 400a as the new first node, nodes 401a and 401b become the next-stage nodes and therefore become the targets of folding.

Propagation delay adjusting unit 8 adjusts propagation delays of a clock, thereby realizing “zero skew.”

Defined third node angle condition storage device 5c stores angle conditions which a defined third node should meet.

Circuit information storage device 10 stores circuit information on a logic circuit inputted through input device 9 or circuit information on a logic circuit on which clock routing is performed by clock routing processing unit 1. Circuit information storage device 10 stores circuit information on a logic circuit after all folding have been completed by folding executing unit 11.

Output device 17 outputs the circuit information inputted through input device 9, the circuit information on the logic circuit on which clock routing is performed by clock routing processing unit 1, the circuit information on the logic circuit after all folding have been completed by folding executing unit 11, and the circuit information stored in circuit information storage device 10.

ROM 18 stores a basic input-output system (BIOS) for booting the system. RAM 19 stores various information and results of operation.

Folding executing unit 11 folds nodes, whereby the number of branches from a route driver toward local areas can be reduced even if the number of the local areas is large. Clock routing can be realized with high integration density while abiding by the constraints of electromigration, within the limit to the number of branches.

First node specifying unit 2 specifies a second node after folding as a new first node, whereby folding of nodes can be sequentially performed in a signal propagation direction after the folding. Accordingly, folding can be performed on all the nodes capable of being folded.

Third node specifying unit 5a specifies a node capable of being folded, whereby folding can be surely performed without increasing the propagation delay of a signal. Accordingly, malfunction after the folding can be prevented.

Third node defining unit 5b defines a third node to be folded, whereby the numbers of segments and nodes are reduced, the space utilization in a chip is increased, and the power consumption is reduced.

Propagation delay adjusting unit 8 adjusts propagation delays, whereby malfunction after the clock routing can be prevented.

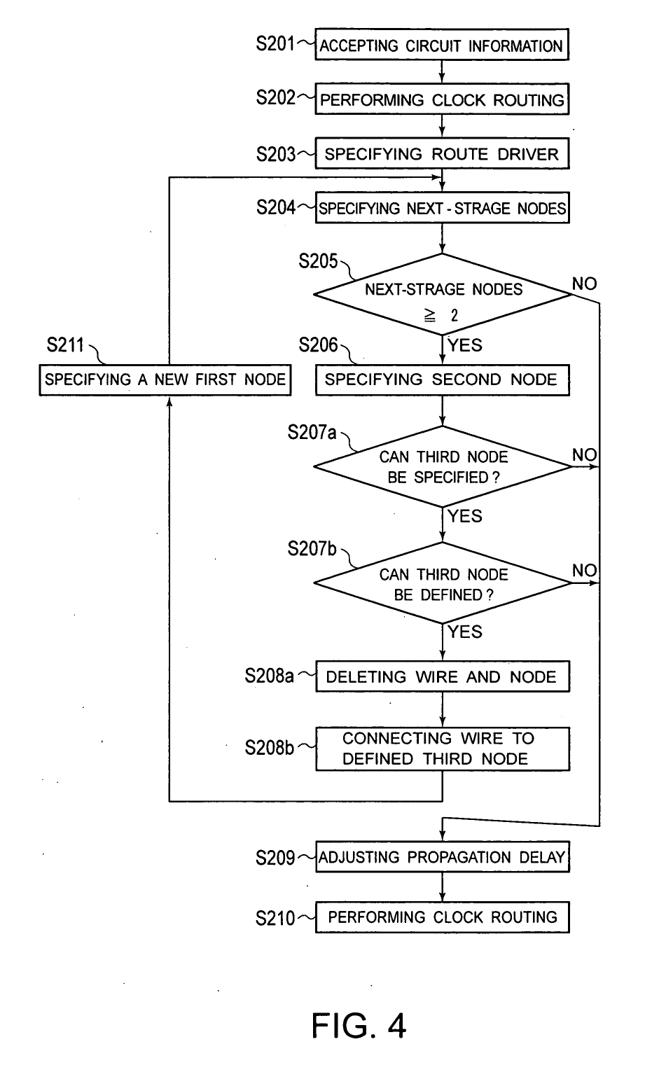

A description will be given of a clock layout method according to the first embodiment of the present invention by using a flow chart of FIG. 4, while referring to FIG. 2, FIGS. 3A and 3B.

(a) First, in a step S201, circuit information on a logic circuit to be designed is inputted by use of input device 9. For example, CPU 100 accepts the circuit information on the logic circuit shown in FIG. 3A, and this circuit information is stored in circuit information storage device 10.

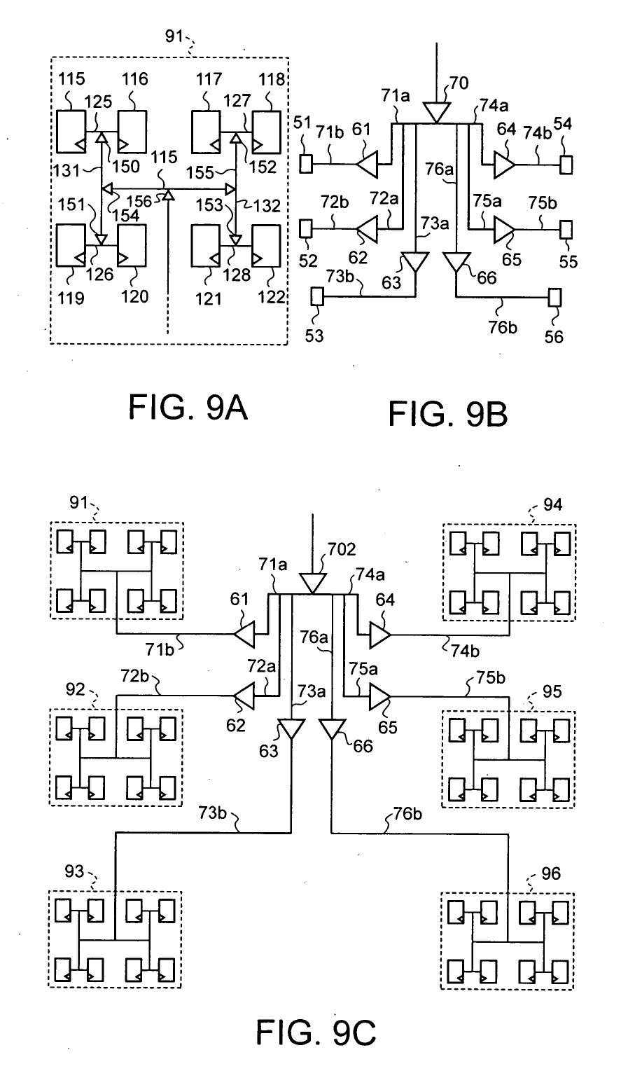

(b) In a step S202, clock routing processing unit 1 places a route driver on a semiconductor chip, based on the circuit information on the logic circuit inputted through input device 9. Clock routing is performed with an H-tree structure in a local area and with a star structure in the global area. In the global area, as shown in FIG. 9C, a plurality of wires 71a to 76a are branched from a route driver 702 placed on a semiconductor chip, thus performing clock routing of a star structure.

(c) In a step S203, based on the circuit information on the logic circuit after the clock routing is performed by clock routing processing unit 1, the route driver is specified as first node 701 by first node specifying unit 2.

(d) In a step S204, nodes 400a, 400b, . . . which first appear in respective signal propagation directions along the plurality of wires 40a, 40b, . . . from first node 701, are specified as next-stage nodes by next-stage node specifying unit 3.

(e) In a step S205, the number of next-stage nodes 400a, 400b, . . . specified by next-stage node specifying unit 3 is counted by next-stage node number counting unit 4.

(f) If the counted number of next-stage nodes 400a, 400b, . . . is two or more, second node specifying unit 14 specifies next-stage node 400a, one of next-stage nodes 400a, 400b, . . . , as a second node, in a step S206.

(g) In a step S207a, on condition that there is at least no increase in propagation delay of a clock propagated from the first node to the third node after folding, third node specifying unit 5a specifies, as a third node, node 401b which first appears in a signal propagation direction from next-stage node 400b different from second node 400a shown in FIG. 3A.

(h) If the third node is specified, third node defining unit 5b defines, as a defined third node, the third node which meets the condition stored in defined third node angle condition storage device 5c, in a step S207b.

(i) In a step S208a, wires 40b, 41b and node 400b on the route branching from first node 701 up to defined third node 401b are deleted by folding target deleting subunit 6.

(j) In a step S208b, wire 41e is branched from second node 400a and connected to defined third node 401b by folding routing processing subunit 7.

(k) When folding toward the defined third node has been performed, second node 400a is specified as a new first node by first node specifying unit 2, in a step S211.

(l) Further, steps S204 to S208 are repeated using the new first node, and through a step S211, nodes are folded one after another in signal propagation directions, thus folding all the nodes capable of being folded. The circuit information on the logic circuit after all the folding have been completed by folding executing unit 11, is stored in circuit information storage device 10.

(m) If there is only one next-stage node in step S205, if the third node is not specified by third node specifying unit 5a in step S207a, or if the defined third node is not defined in step S207b, then propagation delay adjustment is performed by propagation delay adjusting unit 8 in a step S209.

(n) In a step S210, final clock routing is performed by clock routing processing unit 1.

Thus, wires are branched not only from a route driver but also from a node after folding. Even if the number of local areas increases, clock routing processing can be performed without exceeding the limit to the number of branches from the route driver toward the local areas and constraints of electromigration. Moreover, the number of segments and nodes is reduced, whereby the space utilization in a chip is increased, and the power consumption is reduced.

Each of the steps in the above-described clock layout method can be written as a program. By causing a computer to execute these programs, the clock routing processing as described in this embodiment can be performed.

### Second Embodiment

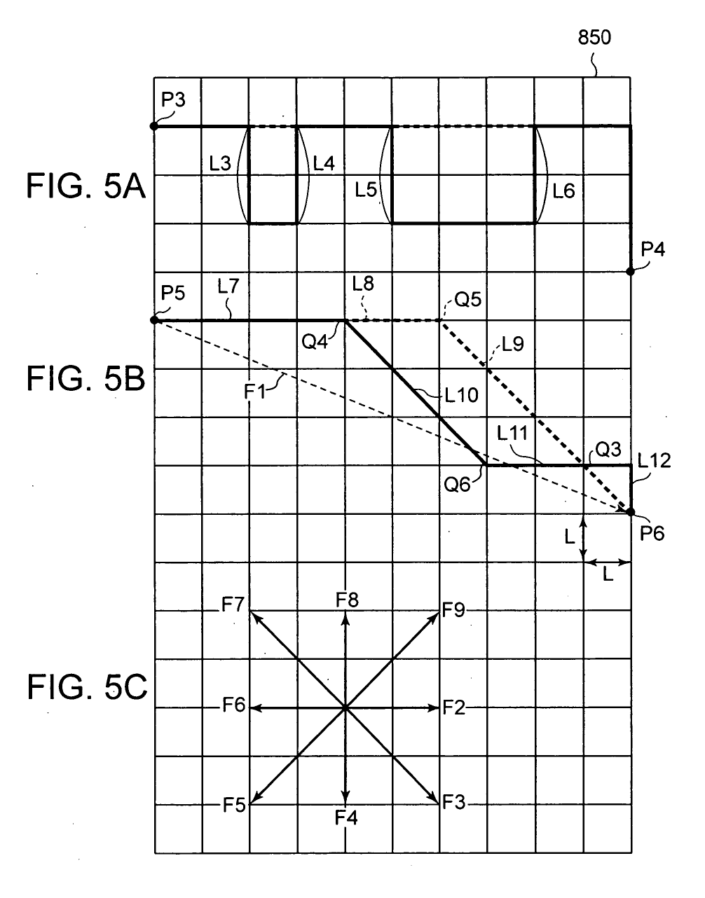

When skew is minimized in such a manner that propagation delays of a clock are adjusted by extending clock wires, an increase in the wiring capacitance in an extended wire will cause degradation of the rise characteristics of a signal. As shown in FIG. 5A, for example, in order to adjust a propagation delay of a clock by use of a wire connecting nodes P3 and P4, the length of the wire is extended with clock wires L3 and L4. Since clock wires L3 and L4 are in close proximity to each other, the wiring capacitance is increased therebetween, thereby causing an increase in the rise time of a signal. On the other hand, in order to avoid an increase in the wiring capacitance, if the length of the wire is extended with wires L5 and L6 which are not in close proximity to each other, the required wiring space is increased.

As shown in FIG. 5B, clock routing in an integrated circuit device according to a second embodiment of the present invention connects an arbitrary node P5 with a next-stage node P6 to which a signal is to be sent after this node. This clock routing is detour clock routing for setting of a target delay, including wires L7, L10, L11, and L12 in wiring directions at angles of less than 90° from a straight direction F1. That is, a propagation delay of a clock is adjusted by using a combination of any of wires in directions F2, F3, F4, and F9 shown in FIG. 5C. Since the wires in directions F2, F3, F4, and F9 are not parallel to one another, it is possible to set a target delay with detour clock routing in which the wires are not parallel to one another, and it is thus possible to prevent an increase in the wiring capacitance and degradation of the rise characteristics of a signal. If a diagonal wiring matrix 860 shown in FIG. 1 is used in addition to an orthogonal wiring matrix 850, it is preferable that a propagation delay of a signal be adjusted with a combination of any of wiring directions in the fourth quadrant. That is, a propagation delay of a clock is adjusted with a combination of any of wires in directions F2, F3 and F4 shown in FIG. 5C. The fourth quadrant is a quadrant of straight direction F1 connecting arbitrary node P5 with next-stage node P6 to which a signal is to be sent after this node.

As shown in FIG. 5B, a propagation delay of a clock has been adjusted with the wires in wiring directions F2, F3 and F4. As a result, the clock routing indicated by the solid line has redundancy between Q3 and P6 as compared with wires L7, L8 and L9 connecting nodes P5 and P6 by the shortest distance. Assuming that the unit length of the grid of orthogonal wiring matrix 850 is L, the above redundancy becomes (2-2^{1/2})L. Even if the clock routing has the redundancy as described above, the propagation delay of the clock can be adjusted with wires L10, L11 and L12 which are not in close proximity to one another. Consequently, it is possible to suppress an increase in the wiring capacitance due to wires L10, L11 and L12. It is possible to adjust a propagation delay of a clock while preventing degradation of the rise characteristics of a signal to propagate between nodes P5 and P6 without increasing the required wiring space.

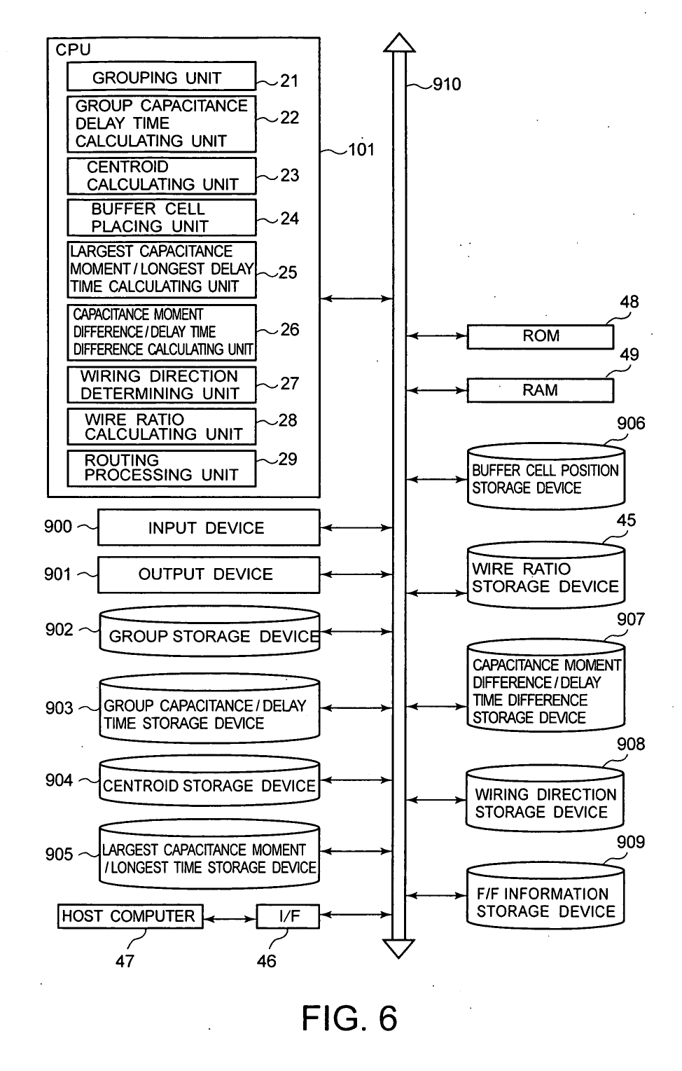

A description will be given of a clock layout system according to the second embodiment of the present invention with reference to FIG. 6. The clock layout system according to the second embodiment of the present invention includes an input device 900, a central processing unit (CPU) 101, an output device 901, an interface 46, a host computer 47, and a common bus 910. The clock layout system according to the second embodiment of the present invention further includes a group storage device 902, a group capacitance/delay time storage device 903, a centroid storage device 904, a buffer cell position storage unit 906, a largest capacitance moment/longest time storage device 905, a wire ratio storage device 45, a capacitance moment difference/delay time difference storage device 907, a wiring direction storage device 908, an F/F information storage device 909, a read only memory (ROM) 48, and a random access memory (RAM) 49.

Input device 900 provides an input of flip-flop (F/F) information on a logic circuit to be designed. Output device 901 outputs data to be subjected to processing and the like by CPU 101. Host computer 47 retains, via interface 46, the same data as the data to be outputted by output device 901 and provides an output of the data on a monitor or the like. Input device 900, CPU 101, output device 901, interface 46, host computer 47, group storage device 902, group capacitance/delay time storage device 903, centroid storage device 904, buffer cell position storage unit 906, largest capacitance moment/longest time storage device 905, wire ratio storage device 45, capacitance moment difference/delay time difference storage device 907, wiring direction storage device 908, F/F information storage device 909, read only memory (ROM) 48, and random access memory (RAM) 49 communicate data with one another via common bus 910.

CPU 101 includes a grouping unit 21, a group capacitance/delay time calculating unit 22, a centroid calculating unit 23, a buffer cell placing unit 24, a largest capacitance moment/longest delay time calculating unit 25, a capacitance moment difference/delay time difference calculating unit 26, a wiring direction determining unit 27, a wire ratio calculating unit 28, and a routing processing unit 29.

Grouping unit 21 groups at least two F/Fs or at least two F/F groups in each of which connection has been already done into a balanced tree, based on the F/F information on the logic circuit to be designed which has been inputted through input device 900.

Group capacitance/delay time calculating unit 22 calculates the capacitance of each group or propagation delay time of a signal in each group which has been grouped by grouping unit 21. The capacitance includes the input capacitances of F/Fs and wiring capacitances.

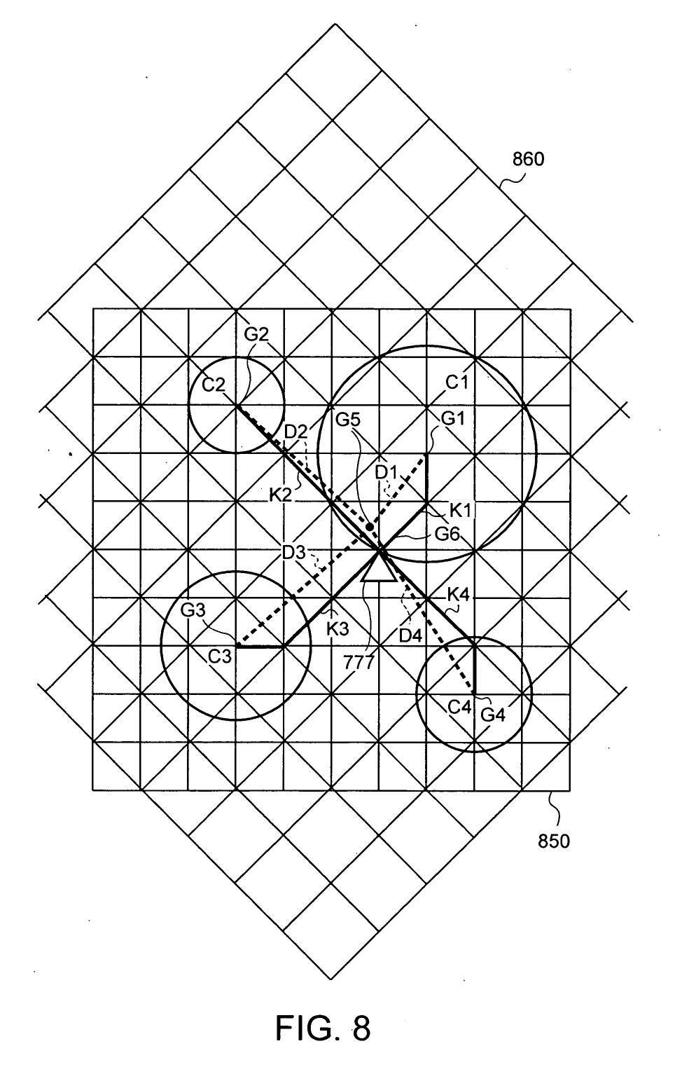

Centroid calculating unit 23 calculates the position of such a point (centroid) as to make the capacitance moments of the groups or the propagation delay times of a signal in the groups equal. The calculation of the position of the centroid is performed as follows. As shown in FIG. 8, in the case where there are four groups grouped by grouping unit 21, the capacitances of the groups are assumed to be C1, C2, C3, and C4, respectively. The euclidean distances from a centroid G5 of the whole to centroids G1, G2, G3, and G4 of the respective groups are assumed to be D1, D2, D3, and D4, respectively, and then the following equation (1) is true.

D1×C1=D2×C2=D3×C3=D4×C4 (1)

A position of G5 which meets the equation (1) is the centroid of the whole. That is, a point which makes all the capacitance moments (DX×CX) equal is the centroid of the whole. Moreover, if it is required to adjust the delay times with more precision in consideration for the wiring resistances, it may be possible to set such a position of G5 as to make the propagation delay times of a signal from centroid G5 to F/Fs in the respective groups equal, as the centroid of the whole.

Buffer cell placing unit 24 places a buffer cell at a position which is the closest to the centroid and proper. Centroid G5 in FIG. 8 is not positioned on the wires. Therefore, a buffer cell 777 is placed at a point G6 which is the closest to centroid G5 and an intersection point of the grids of orthogonal wiring matrix 850 and diagonal wiring matrix 860.

Largest capacitance moment/longest delay time calculating unit 25 calculates the largest one of the capacitance moments of the groups or the longest one of the delay times to the F/Fs in the groups. The capacitance moments of the groups or the delay times to the F/Fs in the groups are those in the case where connection is done with the shortest wire which is actually feasible, from the buffer cell placed by buffer cell placing unit 24 to the centroid of each group. In FIG. 8, for example, it is assumed that connections are done from buffer cell 777 to centroids G1 to G4 of the respective groups with wires K1, K2, K3, and K4 by the shortest distances, using orthogonal wiring matrix 850 and diagonal wiring matrix 860. In this case, largest capacitance moment/longest delay time calculating unit 25 calculates the largest one of the capacitance moments of the groups (D1×C1, D2×C2, D3×C3, D4×C4) or the longest one of the delay times to the F/Fs in the groups.

Capacitance moment difference/delay time difference calculating unit 26 calculates a difference between the largest capacitance moment or longest delay time, which has been calculated by largest capacitance moment/longest delay time calculating unit 25, and the capacitance moment or delay time in another route. In FIG. 8, for example, it is assumed that capacitance moment D2×C2 in wire K2 is the largest. In this case, capacitance moment difference/delay time difference calculating unit 26 calculates differences between the capacitance moment in wire K2 and the capacitance moments in wires K1, K3 and K4.

Wiring direction determining unit 27 determines another wires for adjusting the propagation delay of a signal in each wire. Wiring directions to be determined are a combination of any of directions at angles of less than 90° from a straight direction between nodes to be connected. As shown in FIG. 5B, for example, a combination is determined of any of directions at angles of less than 90° from straight direction F1 connecting arbitrary node P5 with next-stage node P6 to which a signal is to be sent after this node. That is, the propagation delay of a clock is adjusted using a combination of any of wires in directions F2, F3, F4, and F9 shown in FIG. 5C. When diagonal wiring matrix is used in addition to orthogonal wiring matrix 850, it is preferable that the propagation delay of a clock be adjusted using a combination of any of wiring directions present in the fourth quadrant which is the quadrant of straight direction F1 connecting nodes P5 and P6. That is, the propagation delay of a clock is adjusted using a combination of any of the wires in directions F2, F3 and F4 shown in FIG. 5c.

In order to adjust the propagation delay of the clock, wire ratio calculating unit 28 calculates what ratio is used to perform routing for each wiring direction determined by wiring direction determining unit 27. For example, as a result of adjusting the propagation delay of the clock with the wires in directions F2, F3 and F4 as shown in FIG. 5B, there is redundancy between Q3 and P6 as compared with wires L7, L8 and L9 connecting nodes P5 and P6 by the shortest distance. Assuming that the unit length of the grid of orthogonal wiring matrix 850 is L, this redundancy becomes (2-2^{1/2})L. Therefore, assuming that the wire length of L12 is δL, the wire length is increased by (2-2^{1/2})δL after the redundancy is provided. Accordingly, the capacitance moment is increased by C6×(2-2^{1/2})δL (the capacitance of a group with P6 as its centroid is assumed to be C6). Thus, the capacitance moment or delay time can be adjusted by adjusting a wire ratio δ of L12. Even if the redundancy is provided as described above, it is possible to adjust the propagation delay of the clock with wires L10, L11 and L12. As a result, it is possible to suppress an increase in the wiring capacitance due to wires L10, L11 and L12, and it is possible to adjust the propagation delay of the clock while preventing degradation of the rise characteristics of a signal to propagate between nodes P5 and P6 without increasing the required wiring space.

Routing processing unit 29 performs the optimum routing on a substrate, based on the wire ratios calculated by wire ratio calculating unit 28.

Group storage device 902 stores F/F information on the F/Fs grouped by grouping unit 21. Group capacitance/delay time storage device 903 stores each group capacitance or propagation delay time calculated by group capacitance/delay time calculating unit 22. Centroid storage device 904 stores the position of the centroid calculated by centroid calculating unit 23. Buffer cell position storage unit 906 stores the position of the buffer cell placed by buffer cell placing unit 24. Largest capacitance moment/longest time storage device 905 stores the largest capacitance moment or longest time calculated by largest capacitance moment/longest delay time calculating unit 25. Capacitance moment difference/delay time difference storage device 907 stores the differences in the capacitance moment or delay time, calculated by capacitance moment difference/delay time difference calculating unit 26. Wiring direction storage device 908 stores the wiring directions determined by wiring direction determining unit 27. Wire ratio storage device 45 stores the wire ratios calculated by wire ratio calculating unit 28. F/F information storage device 909 stores the F/F information inputted through input device 900. ROM 18 stores a basic input-output system (BIOS) for booting the system. RAM 19 stores various information and results of operation.

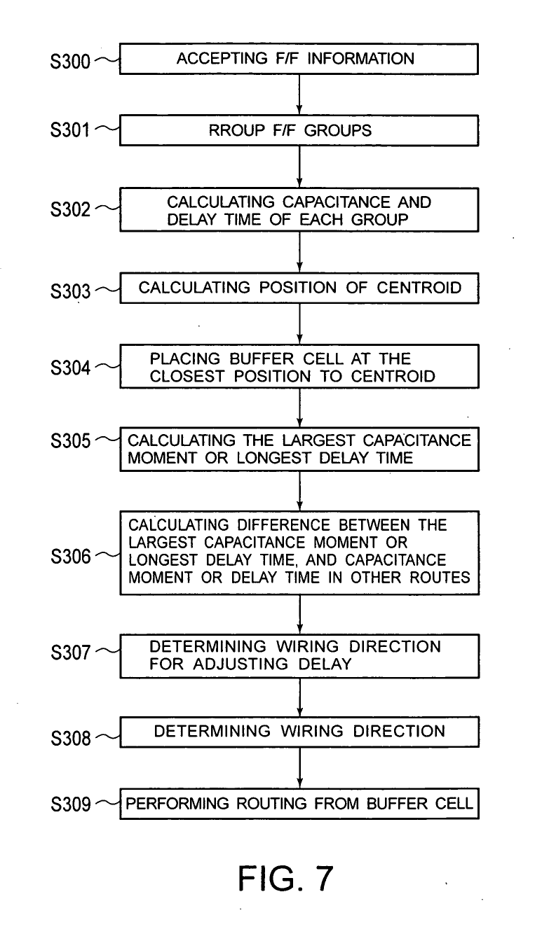

A description will be given of a clock layout method according to the second embodiment of the present invention by using a flow chart of FIG. 7, while referring to FIGS. 6 and 8.

(a) First, in a step S300, F/F information on a logic circuit to be designed is inputted by use of input device 900. The F/F information inputted through input device 900 is stored in F/F information storage device 909. In a step S301, grouping unit 21 groups F/F groups.

(b) In a step S302, group capacitance/delay time calculating unit 22 calculates the capacitance of each group or the propagation delay time of a signal in each group which has been grouped by grouping unit 21.

(c) In a step S303, centroid calculating unit 23 calculates the position of centroid G5 of the groups. In a step S304, buffer cell placing unit 24 places buffer cell 777 at a position which is the closest to centroid G5 and proper.

(d) In a step S305, largest capacitance moment/longest delay time calculating unit 25 calculates the largest one of the capacitance moments of the groups or the longest one of the delay times to the F/Fs in the groups in the case where connections have been done from buffer cell 777 placed by buffer cell placing unit 24 to centroids G1 to G4 of the respective groups with wires K1 to K4 by the shortest distances.

(e) In a step S306, capacitance moment difference/delay time difference calculating unit 26 calculates differences between the largest capacitance moment or longest delay time calculated by largest capacitance moment/longest delay time calculating unit 25, and the capacitance moments or delay times in the other routes.

(f) In a step S307, wiring direction determining unit 27 determines wiring directions for adjusting the propagation delay of a clock in each wire. In a step S308, in order to adjust the propagation delay of the clock (that is, so that a capacitance moment or delay time becomes equal to another one), wire ratio calculating unit 28 calculates what ratio is used to perform routing for each wiring direction determined by wiring direction determining unit 27.

(g) In a step S309, routing processing unit 29 performs routing from buffer cell 777 to each group, based on the wire ratios calculated by wire ratio calculating unit 28.

Each of the steps in the above-described clock layout method can be written as a program. By causing a computer to execute these programs, the clock routing processing described in this embodiment can be performed.

Although buffers are used in the first and second embodiments of the present invention, repeaters may be sufficiently used. The “repeaters” are elements which reproduce and relay signals flowing over the wiring.

What is claimed is:

1. An integrated circuit device including clock routing, comprising:
a first node;
a plurality of wires branching from the first node;
a second node which first appears on a first wire of the plurality of wires; and
a wire connecting only to a third node which exists in a direction within angles of 90 degrees from an input direction of a signal inputted to the second node.

2. An integrated circuit device including clock routing, comprising:
a first node;
a plurality of wires branching from the first node;
a second node which first appears on a first wire of the plurality of wires; and
a wire connecting only to a third node which exists in a direction within angles of 45 degrees from an input direction of a signal inputted to the second node.

3. An integrated circuit device including clock routing for setting of a target delay, comprising:
a node;
a next-stage node to which a signal is to be sent after the node; and
a combination of any of wires in directions at angles of less than 90 degrees from a straight direction connecting the node with the next-stage node.

4. An integrated circuit device including clock routing for setting of a target delay, comprising:
a node;
a next-stage node to which a signal is to be sent after the node; and
at least one wire in a wiring direction present in a quadrant of a straight direction connecting the node with the next-stage node.

5. A clock layout system, comprising:
a clock routing processing unit placing a route driver on a semiconductor chip and performing clock routing with an H-tree structure in a local area and with a star structure in a global area based on circuit information on a logic circuit;
a second node specifying unit specifying, as a second node, a node that first appears on a first wire among a plurality of wires branching from an arbitrary first node in the logic circuit;
a third node specifying unit specifying, as a third node, at least one node that is the second to appear on a wire other than the first wire among the plurality of wires branching from the first node;
a third node defining unit defining, as the defined third node, only the third node that exists in a direction within a predetermined angle from an input direction of a signal inputted to the second node, among the third nodes; and
a folding executing unit folding a wire from the first node up to the defined third node and a node present therebetween.

6. The clock layout system according to claim 5, wherein the predetermined angle used by the third node defining unit is 90 degrees.

7. The clock layout system according to claim 5, wherein the predetermined angle used by the third node defining unit is 45 degrees.

8. A clock layout system, comprising:
a wiring direction determining unit determining at least one wiring direction used for connecting an arbitrary node in a logic circuit with a next-stage node to which a signal is to be sent after the node; and
a wire ratio calculating unit calculating a wire ratio of the wiring direction so that a capacitance moment or delay time becomes equal to another one.

9. The clock layout system according to claim 8, wherein the wiring direction determining unit determines, as the wiring direction, a combination of any of wiring directions at angles of less than 90 degrees from a straight direction connecting the node with the next-stage node.

10. The clock layout system according to claim 8, wherein the wiring direction determining unit determines, as the wiring direction, a combination of any of wiring directions present in a quadrant of a straight direction connecting the node with the next-stage node.

11. A clock layout method, comprising:
accepting circuit information on a logic circuit;
based on the circuit information, placing a route driver on a semiconductor chip and forming initial clock routing with an H-tree structure in a local area and with a star structure in a global area;
specifying, as a second node, a node which first appears on a first wire among a plurality of wires branching from an arbitrary first node in the initial clock routing;
specifying, as a third node, at least one node which is the second to appear on a wire other than the first wire among the plurality of wires branching from the first node;
defining, as the defined third node, only the third node which exists in a direction within a predetermined angle from an input direction of a signal inputted to the second node, among the third nodes; and
folding a wire from the first node up to the defined third node and a node present therebetween.

12. The clock layout method according to claim 11, wherein the predetermined angle is 90 degrees.

13. The clock layout method according to claim 11, wherein the predetermined angle is 45 degrees.

14. A clock layout method, comprising:
accepting circuit information on a logic circuit;
determining at least one wiring direction used for connecting an arbitrary node in the logic circuit with a next-stage node to which a signal is to be sent after the node; and
calculating a wire ratio of the wiring direction so that a capacitance moment or delay time becomes equal to another one.

15. The clock layout method according to claim 14, wherein the step of determining the wiring direction is a step of determining, as the wiring direction, a combination of any of wiring directions at angles of less than 90 degrees from a straight direction connecting the node with the next-stage node.

16. The clock layout method according to claim 14, wherein the step of determining the wiring direction is a step of determining, as the wiring direction, a combination of any of wiring directions present in a quadrant of a straight direction connecting the node with the next-stage node.

17. A clock layout program causing a computer to execute:
accepting circuit information on a logic circuit;
based on the circuit information, placing a route driver on a semiconductor chip and forming initial clock routing with an H-tree structure in a local area and with a star structure in a global area;
specifying, as a second node, a node which first appears on a first wire among a plurality of wires branching from an arbitrary first node in the initial clock routing;
specifying, as a third node, at least one node which is the second to appear on a wire other than the first wire among the plurality of wires branching from the first node;
defining, as the defined third node, only the third node which exists in a direction within a predetermined angle from an input direction of a signal inputted to the second node, among the third nodes; and
folding a wire from the first node up to the defined third node and a node present therebetween.

18. A clock layout program causing a computer to execute:
accepting circuit information on a logic circuit;
determining at least one wiring direction used for connecting an arbitrary node in the logic circuit with a next-stage node to which a signal is to be sent after the node; and
calculating a wire ratio of the wiring direction so that a capacitance moment or delay time becomes equal to another one.
